(19) United States
(12) Patent Application Publication
(10) Pub. No.: US 2008/0141181 A1
(43) Pub. Date: Jun. 12, 2008

(54) INFORMATION PROCESSING APPARATUS, INFORMATION PROCESSING METHOD, AND PROGRAM

(75) Inventors: SATORU ISHIGAKI, Ome-shi (JP); Tsukasa Ike, Tokyo (JP); Yasuhiro Taniguchi, Yokohama-shi (JP); Hisashi Kazama, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/951,760

(22) Filed: Dec. 6, 2007

(30) Foreign Application Priority Data
Dec. 7, 2006 (JP) 2006-330942

(51) Int. Cl. G06F 3/048

(52) U.S. Cl. 715/863

(57) ABSTRACT

According to one embodiment, there is provided an information processing apparatus. A hand-shape database stores first data representing a first hand shape and second data representing a second hand shape. A hand-shape recognition unit determines whether a received image includes one of the first and second hand shapes. The hand-shape recognition unit outputs first predetermined information when the image includes the first hand shape, and outputs second predetermined information when the image includes the second hand shape. When the first predetermined information is received, a gesture interpretation unit displays on a display a user interface including display items each associated with an executable function, and selects one of the display items in accordance with the position information. When the second predetermined information is received in a state where one of the display items is selected, the gesture interpretation unit executes the function associated with the selected display item.

### CROSS-REFERENCE TO RELATED APPLICATIONS

This application is based upon and claims the benefit of priority from Japanese Patent Application No. 2006-330942, filed Dec. 7, 2006, the entire contents of which are incorporated herein by reference.

### BACKGROUND

1. Field

One embodiment of the invention relates to an information processing apparatus, an information processing method, and a program which can recognize a gesture of a user and perform control based on the recognized gesture.

2. Description of the Related Art

Conventionally, methods have been proposed which operate an information processing apparatus, such as a television receiver or a personal computer, by a gesture of a user. According to such methods, it is possible to remotely operate an information processing apparatus without using an input device such as a mouse, a keyboard, or a remote controller.

As an example, Japanese Patent No. 2941207 proposes a method which operates a television receiver by using a one-handed gesture. In this method, upon detection of a trigger gesture, the television receiver enters a control mode, and a hand icon and machine control icons are displayed on a bottom portion of a television screen. The hand icon is moved onto a desired specific machine control icon so as to perform desired control. The television receiver returns to a viewing mode when the user closes his/her hand or stops displaying his/her hand.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram schematically showing an exemplary configuration of an information processing apparatus according to a first embodiment of the invention;

FIG. 2 is an exemplary block diagram showing in detail a part of the configuration of the information processing apparatus shown in FIG. 1;

FIG. 3 is an exemplary block diagram showing an exemplary configuration of a hand-shape recognition unit shown in FIG. 2;

FIG. 4 is an exemplary schematic diagram for explaining an object detection method in an object detection unit shown in FIG. 3;

FIG. 5 is an exemplary block diagram showing an exemplary configuration of a gesture interpretation unit shown in FIG. 2;

FIG. 6 is an exemplary flowchart for explaining an information processing method according to a second embodiment of the invention;

FIG. 7A is an exemplary schematic diagram showing an example of a menu screen displayed in the information processing method shown in FIG. 6;

FIG. 7B is an exemplary schematic diagram showing an example of the menu screen displayed in the information processing method shown in FIG. 6;

FIG. 7C is an exemplary schematic diagram showing an example of the menu screen displayed in the information processing method shown in FIG. 6;

FIG. 7D is an exemplary schematic diagram showing an example of an image photographed by a camera in the information processing method shown in FIG. 6;

FIG. 7E is an exemplary schematic diagram showing an example of the image photographed by the camera in the information processing method shown in FIG. 6;

FIG. 7F is an exemplary schematic diagram showing an example of the image photographed by the camera in the information processing method shown in FIG. 6;

FIG. 8A is an exemplary schematic diagram for explaining a display method for superimposing a camera image on the menu screen;

FIG. 8B is an exemplary schematic diagram showing an example of the camera image to be superimposed on the menu screen;

FIG. 9A is an exemplary schematic diagram showing an example of a high-level menu screen in the case of using a hierarchical structure menu screen;

FIG. 9B is an exemplary schematic diagram showing an example of a low-level menu screen in the case of using the hierarchical structure menu screen;

FIG. 10A is an exemplary schematic diagram showing an example of a high-level menu screen in the case of using a hierarchical structure menu screen;

FIG. 10B is an exemplary schematic diagram showing an example of a low-level menu screen in the case of using the hierarchical structure menu screen;

FIG. 11 is an exemplary flowchart for explaining an information processing method according to a third embodiment of the invention;

FIG. 12A is an exemplary schematic diagram showing an example of a menu screen displayed in the information processing method shown in FIG. 11;

FIG. 12B is an exemplary schematic diagram showing an example of the menu screen displayed in the information processing method shown in FIG. 11;

FIG. 12C is an exemplary schematic diagram showing an example of the menu screen displayed in the information processing method shown in FIG. 11;

FIG. 12D is an exemplary schematic diagram showing an example of an image photographed by a camera in the information processing method shown in FIG. 11;

FIG. 12E is an exemplary schematic diagram showing an example of the image photographed by the camera in the information processing method shown in FIG. 11;

FIG. 12F is an exemplary schematic diagram showing an example of the image photographed by the camera in the information processing method shown in FIG. 11;

FIG. 13 is an exemplary flowchart for explaining an information processing method according to a fourth embodiment of the invention;

FIG. 14A is an exemplary schematic diagram showing an example of a menu screen displayed in the information processing method shown in FIG. 13;

FIG. 14B is an exemplary schematic diagram showing an example of the menu screen displayed in the information processing method shown in FIG. 13;

FIG. 14C is an exemplary schematic diagram showing an example of the menu screen displayed in the information processing method shown in FIG. 13;

FIG. 14D is an exemplary schematic diagram showing an example of an image photographed by a camera in the information processing method shown in FIG. 13;

FIG. 14E is an exemplary schematic diagram showing an example of the image photographed by the camera in the information processing method shown in FIG. 13; and

FIG. 14F is an exemplary schematic diagram showing an example of the image photographed by the camera in the information processing method shown in FIG. 13.

### DETAILED DESCRIPTION

Various embodiments according to the invention will be described hereinafter with reference to the accompanying drawings. In general, according to one embodiment of the invention, an information processing apparatus includes: a display; a hand-shape database which stores first data representing a first hand shape and second data representing a second hand shape; a hand-shape recognition unit which receives an image supplied from a camera, determines whether or not the image includes one of the first hand shape and the second hand shape stored in the hand-shape database, outputs first predetermined information including position information representing a position of the first hand shape within the image when the image includes the first hand shape, and outputs second predetermined information when the image includes the second hand shape; and a gesture interpretation unit which, when the first predetermined information is received from the hand-shape recognition unit, displays on the display a user interface including a plurality of display items each associated with an executable function, selects one of the display items in accordance with the position information included in the first predetermined information, and when the second predetermined information is received from the hand-shape recognition unit in a state where the one of the display items is selected, execute the executable function associated with the selected one of the display items.

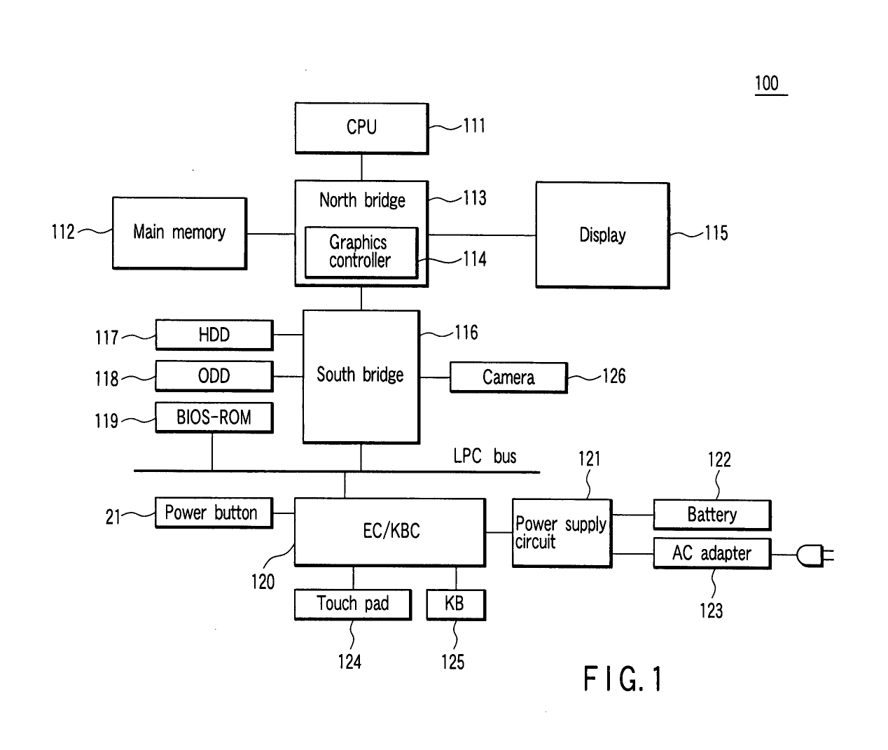

Referring to FIG. 1, a description is given of an information processing apparatus according to a first embodiment of the invention.

FIG. 1 is an exemplary block diagram schematically showing an exemplary configuration of the information processing apparatus according to the first embodiment of the invention. The information processing apparatus is realized as, for example, a notebook personal computer 100.

As shown in FIG. 1, the personal computer 100 includes a CPU 111, a main memory 112, a north bridge 113, a graphics controller (screen display unit) 114, a display 115, a south bridge 116, a hard disk drive (HDD) 117, an optical disk drive (ODD) 118, a BIOS-ROM 119, an embedded controller/keyboard controller IC (EC/KBC) 120, a power supply circuit 121, a battery 122, an AC adapter 123, a touch pad 124, a keyboard (KB) 125, a camera 126, a power button 21, etc.

The CPU 111 is a processor which controls an operation of the personal computer 100. The CPU 111 executes an operating system (OS) and various kinds of application programs which are loaded from the HDD 117 to the main memory 112. Additionally, the CPU 111 also executes a BIOS (Basic Input/Output System) stored in the BIOS-ROM 119. The BIOS is a program for controlling peripheral devices. The BIOS is initially executed when the personal computer 100 is turned ON.

The north bridge 113 is a bridge device connecting a local bus of the CPU 111 to the south bridge 116. The north bridge 113 includes a function of performing communication with the graphics controller 114 via, for example, an AGP (Accelerated Graphics Port) bus.

The graphics controller 114 is a display controller controlling the display 115 of the personal computer 100. The graphics controller 114 generates a display signal to be output to the display 115 from display data which are written to a VRAM (not shown) by the OS or the application programs. The display 115 is, for example, a liquid crystal display (LCD).

The south bridge 116 is connected to the HDD 117, the ODD 118, the BIOS-ROM 119, the EC/KBC 120, and the camera 126. Additionally, the south bridge 116 incorporates therein an IDE (Integrated Drive Electronics) controller for controlling the HDD 117 and the ODD 118.

The EC/KBC 120 is a one-chip microcomputer where an embedded controller (EC) for power management and a keyboard controller (KBC) for controlling the touch pad 124 and the keyboard (KB) 125 are integrated. For example, when the power button 21 is operated, the EC/KBC 120 turns ON the personal computer 100 in combination with the power supply circuit 121. When external power is supplied via the AC adapter 123, the personal computer 100 is driven by the external power. When the external power is not supplied, the personal computer 100 is driven by the battery 122.

The camera 126 is, for example, a USB camera. A USB connector of the camera 126 is connected to a USB port (not shown) provided in a main body of the personal computer 100. An image (moving image) photographed by the camera 126 can be displayed on the display 115 of the personal computer 100. The frame rate of the image supplied by the camera 126 is, for example, 15 frames/second. The camera 126 may be an external camera or a built-in camera of the personal computer 100.

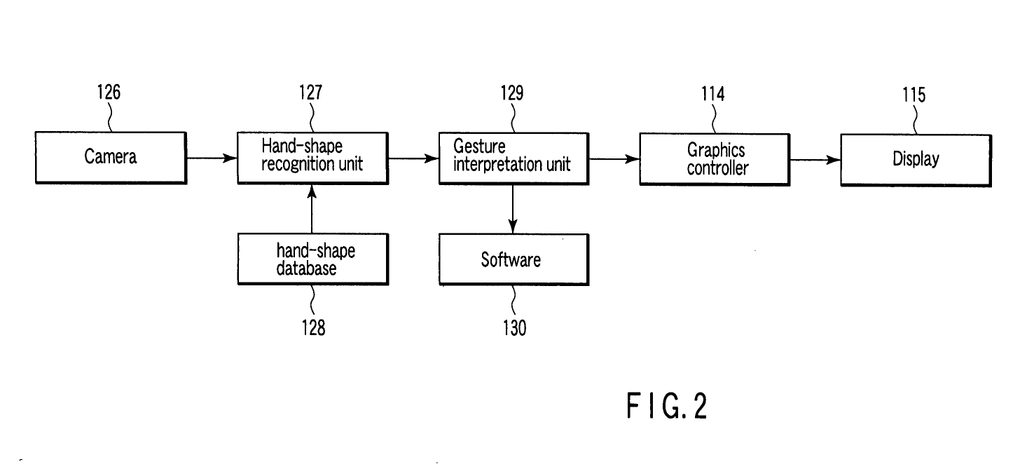

FIG. 2 is an exemplary block diagram showing a part of the configuration of the personal computer 100 in more detail.

As shown in FIG. 2, the image photographed by the camera 126 is supplied to a hand-shape recognition unit 127. The hand-shape recognition unit 127 determines whether or not the supplied image includes a hand shape which matches any one of a plurality of hand shapes stored in (registered with) a hand-shape database 128 in advance. For example, the hand-shape recognition unit 127 searches the image supplied from the camera 126 for one of the hand shapes stored in the hand-shape database 128 in advance.

The hand-shape database 128 stores at least two kinds of hand shapes, i.e., a first hand shape and a second hand shape. For example, the first hand shape may be an open hand (a right hand with five open fingers), and the second hand shape may be a fist (right hand with five bended fingers).

The first hand shape is used for displaying a user interface on the display 115. The user interface includes one or more display items. For example, the user interface may be a user interface (menu) including a plurality of buttons as the display items. Additionally, the user interface may be a user interface including a plurality of sliders as the display items. Further, the user interface may be a user interface including a plurality of dials as the display items.

In addition, the first hand shape is used for moving a cursor (hereinafter referred to as “the user cursor”) which is displayed on the display 115 in accordance with a gesture (e.g., a movement of a hand) of a user. That is, in the case where the hand-shape recognition unit 127 determines that the image supplied from the camera 126 includes the first hand shape, the user interface and the user cursor are displayed on the display 115. It should be noted that the user cursor described herein is different from a cursor displayed on the display 115 by the OS of the personal computer 100.

The second hand shape is used for giving an instruction to execute a function associated with a display item which is selected or operated by the user cursor. Accordingly, when the user merely moves the user cursor onto a display item (e.g., a play button) by using the first hand shape so as to select the display item, the function (e.g., a playback function) associated with the display item is not executed. In the case where the user selects the display item by using the first hand shape, and gives an instruction to execute the function associated with the display item by changing his/her hand shape from the first hand shape to the second hand shape, the function associated with the display item is executed. Hence, it is possible to prevent execution of an unintended function when the user cursor is positioned onto a display item other than a desired display item, while the user is moving the user cursor displayed on the display 115.

It should be noted that the first hand shape and the second hand shape are not limited to the right open hand and the right fist, respectively. Arbitrary hand shapes may be used as the first hand shape and the second hand shape. For example, a left open hand and a left fist can be used as the first hand shape and the second hand shape, respectively. Alternatively, the first hand shape may be a so-called thumbs-up sign (holding up the thumb and bending the other fingers), and the second hand shape may be a hand shape obtained by bending the thumb of the thumbs-up sign. Further, a certain hand shape may be used as the first hand shape, and the second hand shape may be the same hand shape with a tilted angle. For example, the first hand shape may be the above-mentioned thumbs-up sign, and the second hand shape may be a hand shape obtained by rotating the thumbs-up sign to the left at 90 degrees.

In addition to the first hand shape and the second hand shape, the hand-shape database 128 may store a third hand shape to which an independent function (e.g., pause) is assigned.

In the case where the hand-shape recognition unit 127 determines that one of the hand shapes stored in (registered with) the hand-shape database 128 is included in the image supplied from the camera 126, the hand-shape recognition unit 127 supplies predetermined information (an identifier of the hand shape, and position information (e.g., coordinates) of the hand shape within the image) to a gesture interpretation unit 129. For example, when the image includes the first hand shape, first predetermined information is output which includes the position information representing the position of the first hand shape within the image. On the other hand, when the image includes the second hand shape, second predetermined information is output.

Based on the information supplied from the hand-shape recognition unit 127, the gesture interpretation unit 129 displays a plurality of display items, respective selection states of the display items, the user cursor, etc. on the display 115 via the graphics controller, and outputs a command to the software 130 to be operated.

The hand-shape recognition unit 127 and the gesture interpretation unit 129 can be realized by, for example, software which is executed by the CPU 111 (FIG. 1). The software 130 to be operated is stored in the HDD 117 (FIG. 1).

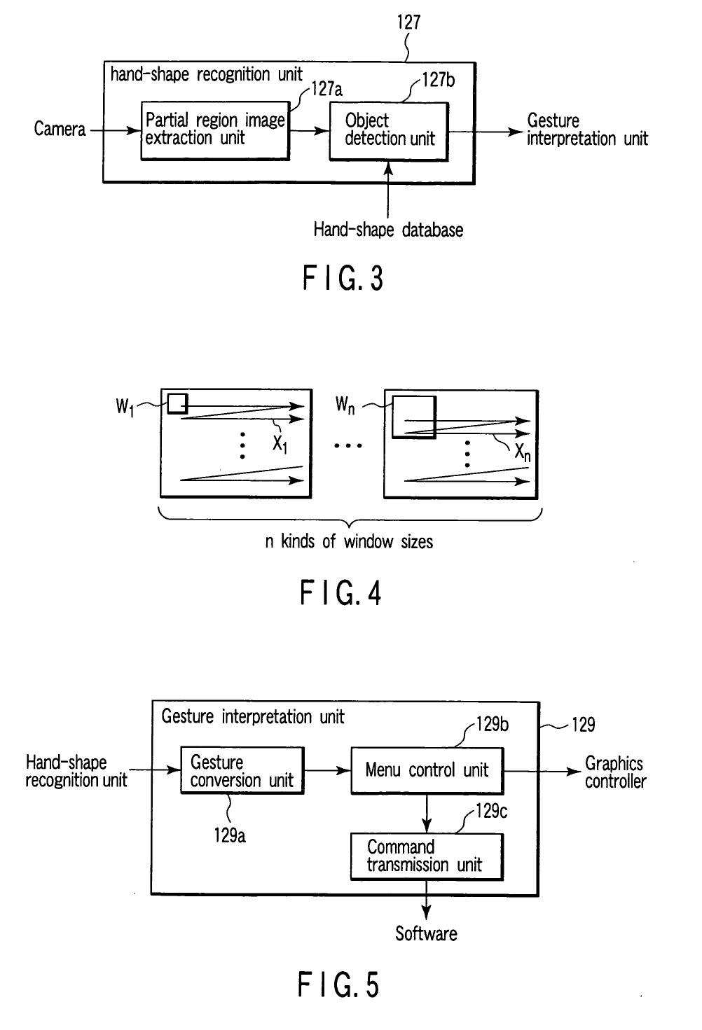

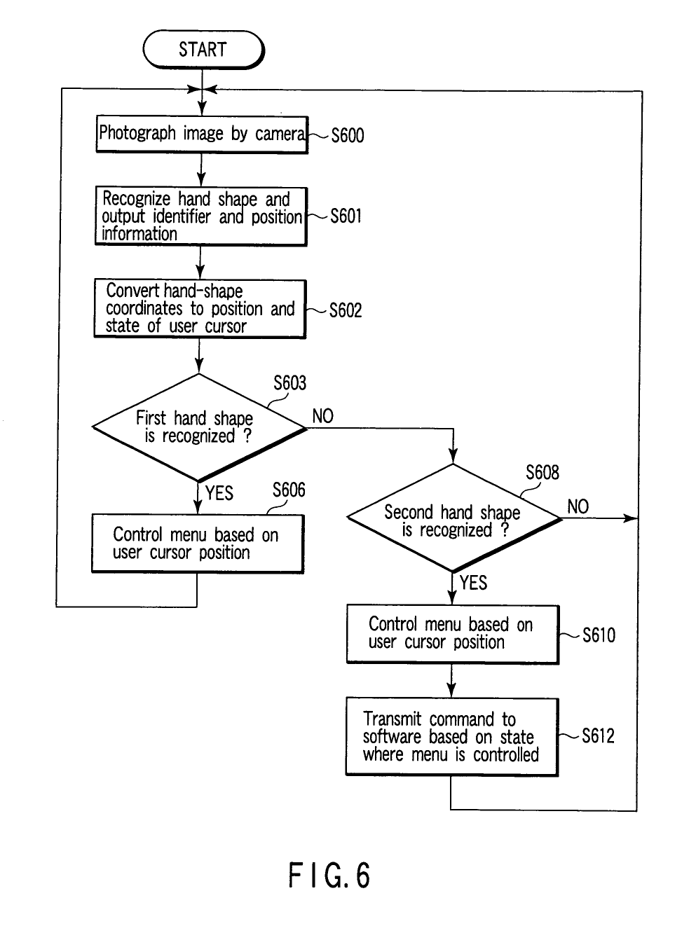

Referring to FIGS. 3 and 4, a more detailed description is given of the hand-shape recognition unit 127.

FIG. 3 is an exemplary block diagram showing in more detail the configuration of the hand-shape recognition unit 127. As shown in FIG. 3, the hand-shape recognition unit 127 includes a partial region image extraction unit 127a and an object detection unit 127b.

The partial region image extraction unit 127a sets various sizes of partial regions on the image supplied from the camera 126 at various positions, extracts an image within each of the partial regions, and supplies the extracted image to the object detection unit 127b. For example, as shown in FIG. 4, the partial regions are set by using n kinds of window sizes (from W₁ to Wₙ, 1<n). The image supplied from the camera 126 is first scanned as indicated by an arrow X₁ in FIG. 4 by using the minimum window size W₁. The window size is sequentially increased until a desired image (a hand shape stored in the hand-shape database 128) is extracted. Finally, the image is scanned as indicated by an arrow Xₙ in FIG. 4 by using the maximum window size Wₙ.

It is conceivable that, in the image supplied from the camera 126, a limited region (e.g., a center portion of the image, a bottom region of the image, etc.) corresponds to those regions from which a gesture of the user (e.g., the first hand shape or the second hand shape) is extracted. Accordingly, the region to be scanned by the partial region image extraction unit 127a may be limited to a fixed region within the image photographed by the camera 126. In this case, it is possible to decrease process load (calculation amount) in the partial region image extraction unit 127a.

The object detection unit 127b normalizes the image supplied from the partial region image extraction unit 127a to a predetermined size. The object detection unit 127b compares the normalized image with the hand shapes stored in the hand-shape database 128, and determines whether any of the hand shapes is included in the normalized image. When it is determined that a hand shape is included within the image, the object detection unit 127b supplies, to the gesture interpretation unit 129, the identifier of the hand shape and the position information of the hand shape within the image. For example, the identifier of the first hand shape may be set to “1”, and the identifier of the second hand shape may be set to “2”. In addition, the identifiers of the first and second hand shapes are not limited to numbers, and characters or strings may be used for the identifiers. The position information of the hand shape within the image is represented by, for example, XY coordinates.

It should be noted that the configuration of the hand-shape recognition unit 127 is not limited to the above-mentioned configuration. The configuration of the hand-shape recognition unit 127 may be any configuration as long as a gesture of a user can be recognized from the image supplied from the camera 126. More specifically, the configuration of the hand-shape recognition unit 127 may be any configuration as long as it is possible to determine whether or not an object to be recognized is included in the image, and when the object is included in the image, it is possible to obtain the position (region) of the object within the image.

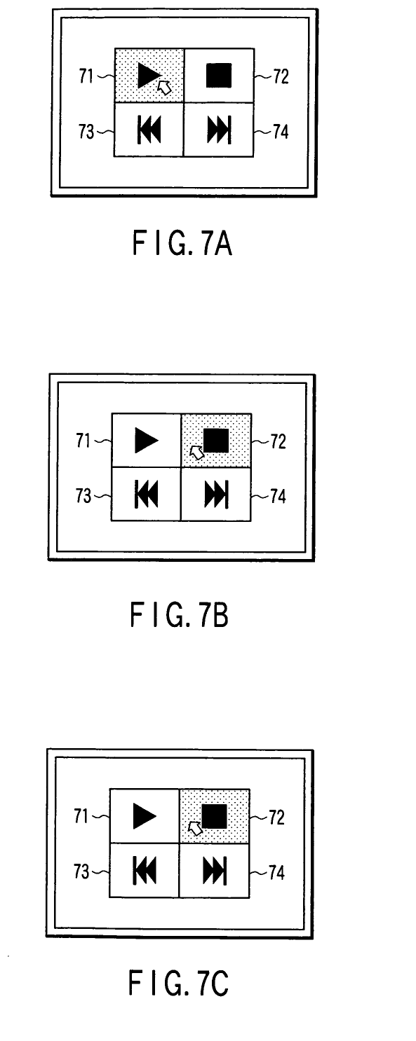

Referring to FIG. 5, a more detailed description is given of the gesture interpretation unit 129.

FIG. 5 is an exemplary block diagram showing in more detail the configuration of the gesture interpretation unit 129. As shown in FIG. 5, the gesture interpretation unit 129 includes a gesture conversion unit 129a, a menu control unit 129b, and a command transmission unit 129c.

The gesture conversion unit 129a converts the position information and the identifier of the hand shape received from the object detection unit 127b of the hand-shape recognition unit 127 into information representing the position and the state (a user cursor moving state (corresponding to the first hand shape) or a selecting state (corresponding to the second hand shape)) of the user cursor. The gesture conversion unit 129a supplies the information to the menu control unit 129b. In addition, the gesture conversion unit 129a can control the relationship between the position of the hand shape and the position of the user cursor, and the relationship between the hand shape and the state of the user cursor. For example, it is possible for the gesture conversion unit 129a to identify three or more kinds of hand shapes, and to allow the user to set hand shapes to be used for the first hand shape and the second hand shape. The gesture conversion unit 129a can control the user cursor by using one of two kinds of methods, i.e., an absolute coordinate method and a relative coordinate method, which will be described later.

The menu control unit 129b controls the state (e.g., a selected state or a non-selected state) of display items in accordance with the information received from the gesture conversion unit 129a, and supplies, to the graphics controller 114, signals for controlling various kinds of display items (e.g., a menu including buttons, a slider bar, a dial, etc.) displayed on the display 115 in accordance with the states of the display items. In addition, the menu control unit 129b gives an instruction to the command transmission unit 129c in accordance with the information received from the gesture conversion unit 129a. For example, when the user changes the first hand shape to the second hand shape in a state where a button (e.g., a play button) included in a menu displayed on the display 115 is selected by using the first hand shape, the menu control unit 129b gives the command transmission unit 129c an instruction for executing a function (e.g., a playback function) associated with the button.

The command transmission unit 129c transmits, to the software (e.g., AV software) 130 to be operated, a command in accordance with the instruction from the menu control unit 129b. For example, when the command transmission unit 129c receives the instruction for executing the function (e.g., the playback function) associated with the button (e.g., the play button) included in the menu, the command transmission unit 129c transmits, to the software 130, a command to execute the function.

As mentioned above, with the personal computer 100 according to the first embodiment of the invention, it is possible to provide an information processing apparatus which can execute a lot of functions by using a small number of gestures and can prevent execution of an unintended function.

Additionally, in the above description, the information processing apparatus according to the first embodiment of,the invention is realized as the personal computer 100. However, the information processing apparatus according to the first embodiment of the invention can be realized as a television receiver, a desktop personal computer, or a game machine.

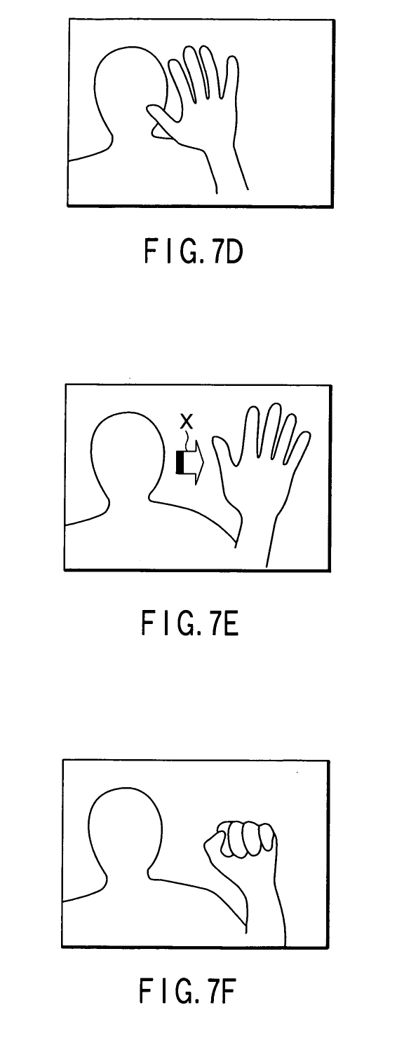

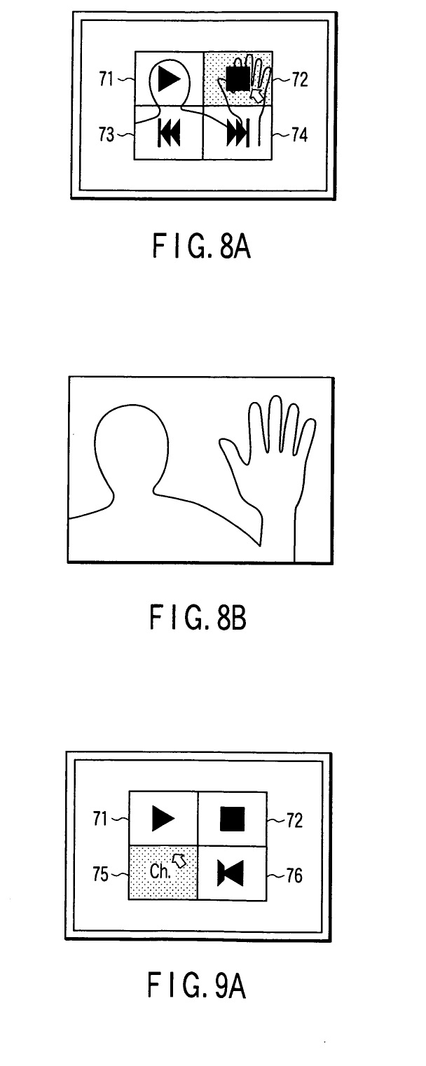

Referring to FIG. 6 and FIGS. 7A through 7F, a description is given of a process of controlling a menu by gestures as a second embodiment of the invention. In an information processing method according to the second embodiment, when the user uses the first hand shape, a menu including a plurality of kinds of buttons are displayed on the display 115. Hereinafter, a description is given of an exemplary case where the information processing method according to the second embodiment of the invention is applied to the personal computer 100 shown in FIG. 1. Additionally, in the following description, it is assumed that an open hand (right hand) is used as the first hand shape, and a fist (right hand) is used as the second hand shape.

FIG. 6 is an exemplary flowchart for explaining the information processing method according to the second embodiment of the invention. FIGS. 7A, 7B and 7C are exemplary schematic diagrams showing examples of a menu displayed on the display 115 of the personal computer 100. FIGS. 7D, 7E and 7F are exemplary schematic diagrams showing examples of the image of the user photographed by the camera 126.

First, the image of the user is photographed by the camera 126 (S600). For example, the image as shown in FIG. 7D is photographed by the camera 126, and the image is supplied from the camera 126 to the hand-shape recognition unit 127. The hand-shape recognition unit 127 recognizes a hand shape included in the supplied image, and outputs the identifier and coordinates of the hand shape (S601). In other words, in S601, the hand-shape recognition unit 127 determines whether or not the supplied image includes the first hand shape.

When any of the hand shapes stored in (registered with) the hand-shape database 128 is included in the supplied image (FIG. 7D), the hand-shape recognition unit 127 supplies, to the gesture interpretation unit 129, predetermined hand-shape coordinate information including the position information and identifier of the hand shape. The gesture interpretation unit 129 interprets a gesture of the user based on the supplied information, and changes the position and state of the user cursor (S602). When the first hand shape (i.e., open hand) is recognized by the hand-shape recognition unit 127 (YES in S603), i.e., when the supplied image includes the first hand shape, based on the interpretation result, the gesture interpretation unit 129 controls the menu displayed on the display 115 via the graphics controller 114 (S606). For example, when a display item (e.g., a button included in the menu) is selected, the gesture interpretation unit 129 changes the display state of the display item. When it is determined for the first time that the supplied image includes the first hand shape, the menu and the user cursor which are shown in FIG. 7A, for example, are displayed on the display 115. The menu shown in FIG. 7A includes four kinds of buttons, i.e., a play button 71, a stop button 72, a fast-rewind button 73, and a fast-forward button 74. Additionally, in FIG. 7A, the user cursor is shown as a small arrow within the play button 71. The user cursor is not limited to the small arrow as shown in FIG. 7A, and may be in an arbitrary shape.

The process of S600 through S606 is repeated until the user changes his/her right hand from the first hand shape (open hand) to the second hand shape (fist). In other words, the process of S600 through S606 is repeated as long as the user is moving the user cursor by using the first hand shape.

Here, an exemplary case is assumed where an image after the user moves his/her right hand in the first hand shape in a direction indicated by an arrow X as shown in FIG. 7E is supplied to the hand-shape recognition unit 127 from the camera 126 (S600). In this case, the hand-shape recognition unit 127 recognizes a hand shape included in the supplied image (FIG. 7E), and outputs the identifier and coordinates of the hand shape (S601). Then, the gesture interpretation unit 129 interprets the gesture of the user based on the supplied information, changes the position and state of the user cursor (S602), and determines that the first hand shape is included (YES in S603). Based on the interpretation result, the menu and the user cursor displayed on the display 115 are controlled (S606). More specifically, as shown in FIG. 7B, the position of the user cursor is moved to a position within the stop button 72 (FIG. 7B) from the position within the play button 71 (FIG. 7A). In addition, the display state of the menu is controlled to be changed to a display state (FIG. 7B) indicating that the stop button 72 is selected from a display state (FIG. 7A) indicating that the play button 71 is selected.

As for the display state of the selected button, various display states are conceivable: changing of the display color of the selected button; blinking of the selected button; and displaying the outline of the selected button with bold lines. However, the display state of the selected button is not limited to the display states as listed above. An arbitrary display state can be employed as long as the display state can inform the user of a button which is currently selected.

On the other hand, as a result of interpreting the output from the hand-shape recognition unit 127 by the gesture interpretation unit 129, when it is determined that the supplied image does not include the first hand shape (NO in S603), the gesture interpretation unit 129 determines whether or not the supplied image includes the second hand shape (S608).

When it is determined that the supplied image does not include the second hand shape (NO in S608), the process returns to S600. In other words, since the photographed image includes neither the first hand shape (NO in S603) nor the second hand shape (NO in S608), the menu is not displayed on the display 115.

On the other hand, when it is determined that the supplied image includes the second hand shape (YES in S608), based on the interpretation result, the gesture interpretation unit 129 controls the menu displayed on the display 115 via the graphics controller 114 (S610), and transmits a command to the software 130 to be operated (S612).

For example, a case is assumed where, in a state where the stop button 72 is selected as shown in FIG. 7C, the image shown in FIG. 7F is photographed by the camera 126 (S600). In this case, the photographed image (FIG. 7F) includes the second hand shape (fist). Accordingly, the hand-shape recognition unit 127 supplies, to the gesture interpretation unit 129, the identifier (e.g., “2”) of the second hand shape and the position information indicating that the second hand shape is located at coordinates (e.g., (x, y)=(12, 5)) corresponding to the stop button 72. Based on the information supplied from the hand-shape recognition unit 127, the gesture interpretation unit 129 interprets that a function of the stop button 72 is selected (S610), and transmits a command to the software 130 so as to execute the function (e.g., a function of stopping playback of an image) associated with the stop button 72 (S612). Then, the process returns to S600.

It should be noted that display of the menu may be ended when a button included in the menu is selected by using the first hand shape, and execution of the function is instructed by using the second hand shape. Alternatively, the menu may additionally include a button for ending display of the menu, and display of the menu may be ended when the button is selected and execution of the function is instructed. Further, display of the menu may be ended when an image is photographed by the camera 126 which includes neither the first hand shape nor the second hand shape.

With the above-mentioned information processing method according to the second embodiment of the invention, it is possible for the user to execute a lot of functions merely by remembering two kinds of hand shapes (the first hand shape and the second hand shape). Accordingly, it is unnecessary for the user to remember many kinds of gestures, and thus user's burden is reduced. In addition, since the menu including the buttons for executing various kinds of functions are displayed on the display 115, the user can easily confirm what kinds of functions can be executed. Further, since the user cursor is displayed on the display 115, the user can easily confirm which function is currently selected.

Additionally, merely selecting a button (e.g., the play button 71) included in the menu by using the first hand shape does not cause execution of the function associated with the selected button. When the user changes his/her right hand (or left hand) from the first hand shape to the second hand shape, the function associated with the selected button is executed. Accordingly, even if the user cursor is located on an unintended button while the user is moving the user cursor, it is possible to prevent erroneous execution of the function associated with the button.

Further, the menu can be displayed on the display 115 when it is determined the supplied image includes the first hand shape, and display of the menu may be ended when it is determined that the supplied image includes neither the first hand shape nor the second hand shape. Thus, the user can display the menu on the display 115 according to need. Additionally, a menu including buttons associated with various kinds of functions may be displayed on the display 115 by using the entire screen of the display 115.

Here, a description is given of a method of moving the user cursor.

There are two kinds of method, the absolute coordinate method and the relative coordinate method, for controlling the user cursor. In the absolute coordinate method, the position of a user's right hand within an image photographed by the camera 126 corresponds to the position of the user cursor on the display 115 in a one-to-one manner. On the other hand, in the relative coordinate method, the user cursor is moved in accordance with the distance between the position of a hand in a previous frame and the position of the hand in a current frame.

In the absolute coordinate method, each of a plurality of regions within an image (or a fixed region within the image) photographed by the camera 126 corresponds to a position of the user cursor on the display 115 (or the menu). When the user's right hand is located at a specific position within the photographed image, the user cursor is displayed on a corresponding position of the display 115. In the case of using the absolute coordinate method, it is possible to directly move the user cursor to an arbitrary position (e.g., a region corresponding to the play button 71) of the display 115 (or the menu). Additionally, the menu can be hidden (display of the menu can be ended) when none of the hand shapes stored in the hand-shape database 128 is recognized. Further, in the case of using the absolute coordinate method, it is possible to employ a display method of superimposing a menu screen on a photographed image.

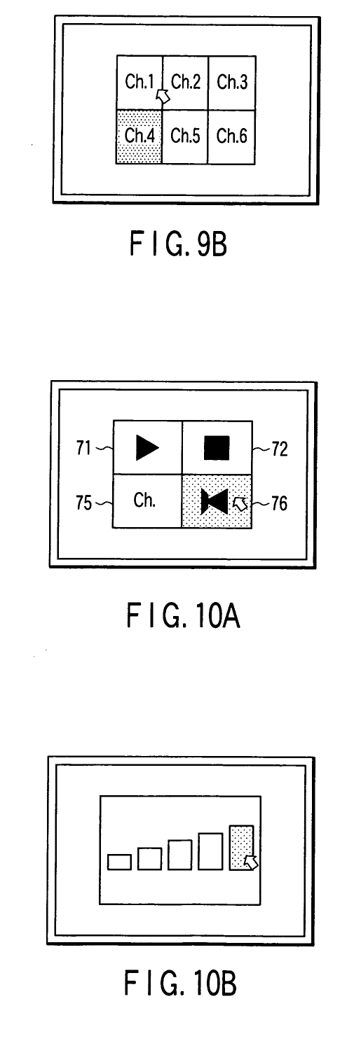

FIGS. 8A and 8B are exemplary schematic diagrams for explaining the display method of superimposing a menu screen on an image photographed by the camera 126. As shown in FIG. 8A, it is possible to superimpose the menu displayed on the display 115 on the image (FIG. 8B) photographed by the camera 126, such that the position of the user cursor matches the position of the hand within the photographed image. By employing such a display method, the user can easily recognize which part of his/her body corresponds to the user cursor, and how much he/she has to move his/her hand in order to move the user cursor to a desired position on the display 115. Consequently, it is possible to improve operability. In the case of employing the display method as shown in FIG. 8A, the user can easily recognize which position of the menu the position of his/her right hand (or left hand) corresponds to. Thus, the user cursor may not be displayed on the display 115.

On the other hand, in the relative coordinate method, the user cursor is moved in accordance with the amount of movement of a user's hand. By reducing the ratio of the amount of movement of the user's hand to the amount of movement of the user cursor, it is possible to control the user cursor with an accuracy higher than that of the absolute coordinate method.

Additionally, the above-mentioned menu including the four kinds of buttons may be a menu (hereinafter referred to as “the hierarchical menu”) having a hierarchical structure.

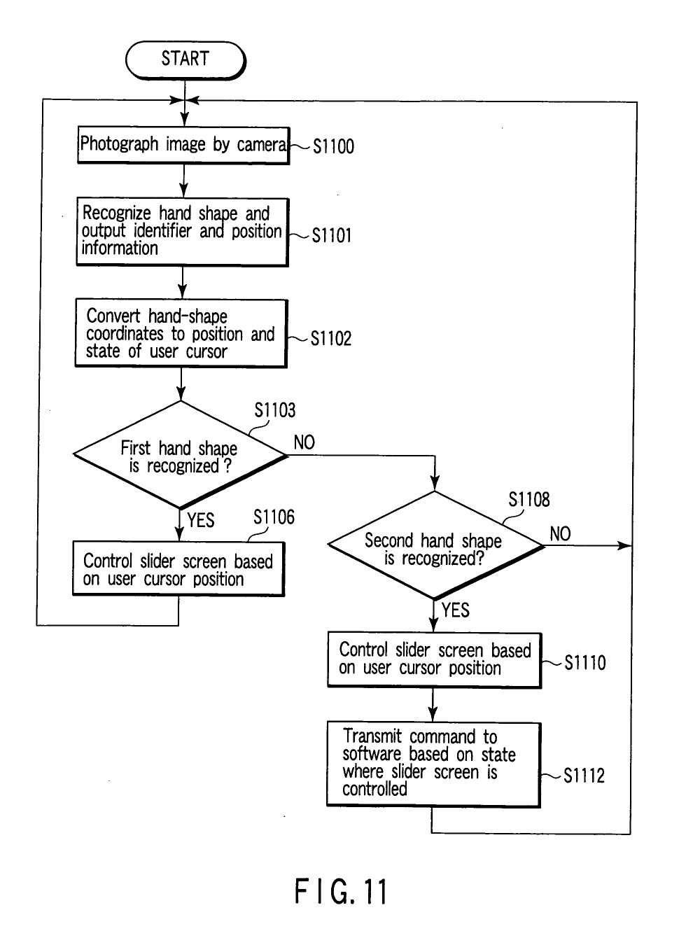

FIG. 9A is an exemplary schematic diagram showing an example of a high-level menu, and FIG. 9B is an exemplary schematic diagram showing an example of a lower-level menu in the case of using the hierarchical menu.

The menu (the high-level menu) shown in FIG. 9A includes the play button 71, the stop button 72, a channel selection button (Ch.) 75, and a volume control button 76. In a state where the channel selection button 75 is selected by the user by moving the user cursor onto the channel selection button 75 by using the first hand shape (open hand), when the user changes his/her hand from the first hand shape to the second hand shape (fist), a function associated with the channel selection button 75 is executed. That is, a channel selection menu shown in FIG. 9B is displayed on the display 115.

The channel selection menu (the lower-level menu) shown in FIG. 9B includes six buttons corresponding to channels 1 through 6. In a state where the user selects a button corresponding to a desired channel by using the first hand shape, and the button is selected, when the first hand shape is changed to the second hand shape, a program of the desired channel is displayed on the display 115. For example, as shown in FIG. 9B, in a state where the user selects a button Ch.4 corresponding to a channel 4 by using an open hand, and the button Ch.4 is selected, when the user's right hand is changed from an open hand to a fist, a program of the channel 4 is displayed on the display 115.

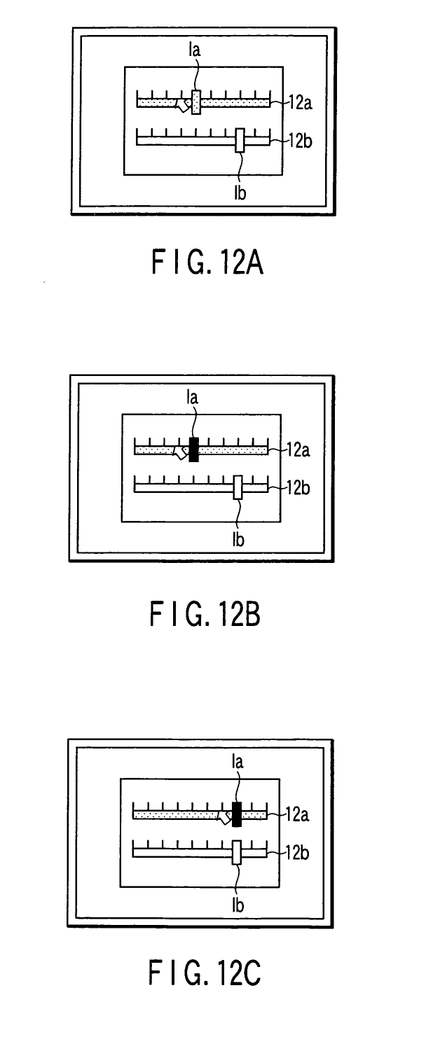

FIG. 10A shows an exemplary state where the volume control button 76 is selected in the case of using the hierarchical menu shown in FIG. 9A. In this case, a volume control menu (a lower-level menu) as shown in FIG. 10B is displayed. The volume control menu represents volume levels by using a plurality of columns having different heights. The user can select one of the columns by using the first hand shape. For example, FIG. 10B shows a state where a rightmost column is selected, i.e., the maximum volume is selected. In this state, when the user changes his/her right hand from the first hand shape to the second hand shape, the volume is turned up to the maximum volume.

By using the hierarchical menu as mentioned above, it is possible to execute various functions while reducing the number of display items displayed on the display 115 at a time.

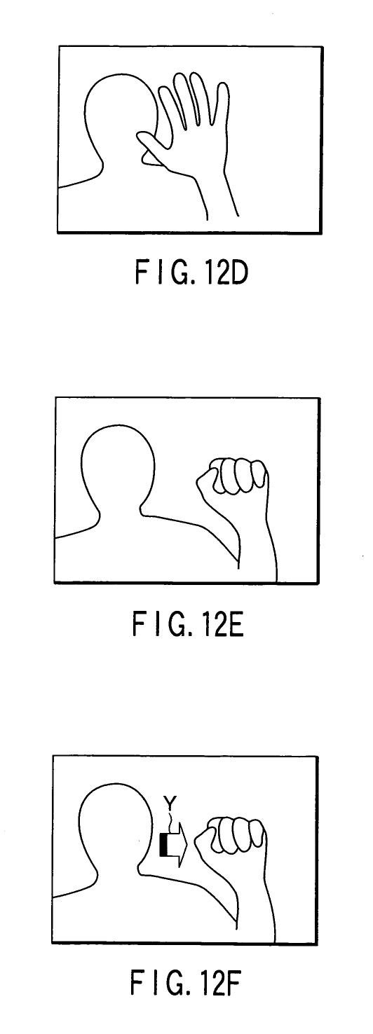

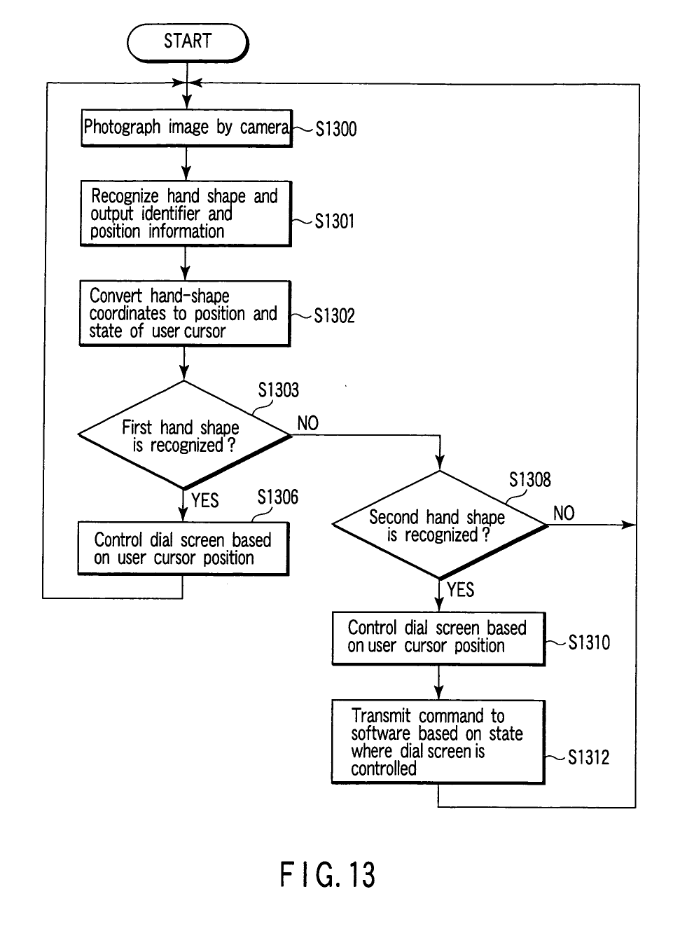

Referring to FIG. 11 and FIGS. 12A through 12F, a description is given of a process of controlling a slider bar by gestures as a third embodiment of the invention. In an information processing method according to the third embodiment, when the user uses the first hand shape, a slider bar is displayed on the display 115. Hereinafter, a description is given of an exemplary case where the information processing method according to the third embodiment of the invention is applied to the personal computer 100 shown in FIG. 1. Additionally, in the following description, it is assumed that an open hand is used as the first hand shape, and a fist is used as the second hand shape.

FIG. 11 is an exemplary flowchart for explaining the information processing method according to the third embodiment of the invention. FIGS. 12A, 12B and 12C are exemplary schematic diagrams showing examples of a slider bar displayed on the display 115 of the personal computer 100. FIGS. 12D, 12E and 12F are exemplary schematic diagrams showing examples of the image of the user photographed by the camera 126.

First, the image of the user is photographed by the camera 126 (S1100). On this occasion, an image as shown in FIG. 12D, for example, is photographed. The photographed image is supplied from the camera 126 to the hand-shape recognition unit 127. The hand-shape recognition unit 127 recognizes a hand shape included in the supplied image, and outputs the identifier and coordinates of the hand shape (S1101). In other words, in S1101, the hand-shape recognition unit 127 determines whether or not the supplied image includes the first hand shape.

When any of the hand shapes stored in (registered with) the hand-shape database 128 is included in the supplied image (FIG. 12D), the hand-shape recognition unit 127 supplies, to the gesture interpretation unit 129, predetermined hand-shape coordinate information including the identifier and the position information of the hand shape. The gesture interpretation unit 129 interprets a user's gesture based on the supplied information, and changes the position and state of the user cursor (S1102). When the first hand shape (i.e., open hand) is recognized by the hand-shape recognition unit 127 (YES in S1103), i.e., when the supplied image includes the first hand shape, based on the interpretation result, the gesture interpretation unit 129 controls the graphics controller 114 so as to display a slider bar on the display 115 (S1106). When it is determined for the first time that the supplied image includes the first hand shape, the user cursor and two kinds of slider bars 12a and 12b as shown in FIG. 12A, for example, are displayed on the display 115, and the process returns to S1100. Here, it is assumed that the slider bar 12a is associated with a volume adjusting function of the personal computer 100, and the slider bar 12b is associated with the brightness of the display 115. It is also assumed that the volume is turned up as a slider Ia of the slider bar 12a is moved to the right in FIG. 12A, and the brightness is increased as a slider Ib of the slider bars 12b is moved to the right in FIG. 12A. When the slider bar 12a is selected by the user cursor, the display color of the slider bar 12a can be changed, so as to inform the user of a fact that the slider bar 12a is currently selected.

The process of S1100 through S1106 is repeated until the user changes his/her right hand from the first hand shape (open hand) to the second hand shape (fist). In other words, the process of S1100 through S1106 is repeated as long as the user is moving the user cursor by using the first hand shape.

On the other hand, as a result of interpreting the output from the hand-shape recognition unit 127 by the gesture interpretation unit 129, when it is determined that the supplied image does not include the first hand shape (NO in S1103), the gesture interpretation unit 129 determines whether or not the supplied image includes the second hand shape (S1108). When it is determined that the supplied image does not include the second hand shape (NO in S1108), the process returns to S1100.

For example, a case is assumed where an image including the second hand shape (fist) as shown in FIG. 12E is supplied from the camera 126 (S1100). In this case, the gesture interpretation unit 129 determines that the supplied image (FIG. 12E) does not include the first hand shape (NO in S1103) but includes the second hand shape (fist) (YES in S1108). Based on the interpretation result, the gesture interpretation unit 129 controls, via the graphics controller 114, a slider screen which includes the slider bars 12a and 12b and is displayed on the display 115 (S1110), and transmits a command to the software 130 to be operated (S1112).

For example, in a state where the slider bar 12a, which is associated with the volume adjusting function, is selected (FIG. 12A), when it is determined that the image includes the second hand shape (YES in S1108), the slider Ia of the slider bar 12a enters a state allowing dragging. On this occasion, by changing the display state of the slider Ia as shown in FIG. 12B, it is possible to inform the user of the state where the slider Ia can be dragged.

As for the display states of a selected slider bar (12a, 12b) and the slider (Ia, Ib) which can be dragged, various display states are conceivable: changing of the display color of the selected slider bar and slider; blinking of the selected slider bar and slider; and displaying the outlines of the selected slider bar and slider with bold lines. However, the display states of the selected slider bar and slider are not limited to the display states as listed above. Arbitrary display states can be employed as long as the display states can inform the user of the slider bar and slider which are currently selected (which can be dragged). For example, the selected slider bar (12a or 12b) may be displayed in an enlarged manner.

Next, a case is assumed where an image is photographed by the camera 126 after the user moves his/her right hand in a direction indicated by an arrow Y in FIG. 12F while maintaining his/her right hand in the second hand shape in a state (draggable state) where the slider Ia can be dragged (FIG. 12B) (S1108). In this case, the hand-shape recognition unit 127 supplies, to the gesture interpretation unit 129, the identifier (e.g., “2”) of the second hand shape and the position information (e.g., (x, y)=(15, 4)) after the movement (S1110). The gesture interpretation unit 129 interprets the user's gesture based on the supplied information (S1110). Based on the interpretation result, the gesture interpretation unit 129 displays the slider Ia on the display 115 at a position corresponding to the supplied position information (S1110), and transmits a command to the software 130 to turn up the volume (S1112).

Display of the slider bars 12a and 12b may be ended after the position of one of the slider Ia of the slider bar 12a and the slider Ib of the slider bar 12b is changed. Additionally, a button for ending display of the slider bars 12a and 12b may be displayed together with the slider bars 12a and 12b, and display of the slider bars 12a and 12b may be ended when the user changes his/her right hand from the first hand shape to the second hand shape in a state where the user is selecting the button by using the first hand shape. Further, display of the slider bars 12a and 12b may be ended when an image is photographed by the camera 126 which includes neither the first hand shape nor the second hand shape.

Although the above description is given of the case where the two kinds of slider bars 12a and 12b are displayed on the display 115, the number of slider bars displayed on the display 115 may be three or more. Alternatively, only one kind of slider bar may be displayed on the display 115. In this case, without performing control of changing the display state of a selected slider bar, a slider may enter a draggable state when it is determined that a photographed image includes the second hand shape.

Further, the menu shown in FIGS. 7A through 7C may be displayed on the display 115 together with the slider bars 12a and 12b shown in FIGS. 12A through 12C.

With the above-mentioned information processing method according to the third embodiment of the invention, it is possible for the user to perform setting of a continuous value, such as the brightness of a display or the volume of a speaker, merely by remembering two kinds of hand shapes (the first hand shape and the second hand shape). Accordingly, it is unnecessary for the user to remember many kinds of gestures, and thus user's burden is reduced. In addition, since the user cursor is displayed on the display 115, the user can easily confirm which slider bar is currently selected. Further, in the case where a plurality of kinds of slider bars are displayed on the display 115, the display state of a selected slider bar is changed. Thus, the user can easily confirm which slider bar is selected.

Additionally, merely selecting a slider bar (12a or 12b) by using the first hand shape does not change the position of a slider of the selected slider bar. When the user changes his/her right hand (or left hand) from the first hand shape to the second hand shape, the slider of the selected slider bar is controlled such that the position of the slider can be changed. Accordingly, even if the slider is moved to an unintended position while the user is moving the user cursor, it is possible to prevent the continuous value (e.g., volume) associated with the slider bar from being changed to an erroneous value.

Further, the slider bars 12a and 12b can be displayed on the display 115 when it is determined that the photographed image includes the first hand shape, and display of the slider bars 12a and 12b may be ended when it is determined that the photographed image includes neither the first hand shape nor the second hand shape. Thus, the user can display the slider bars 12a and 12b on the display 115 according to need. Additionally, the slider bars 12a and 12b may be displayed on the display 115 by using the entire screen of the display 115.

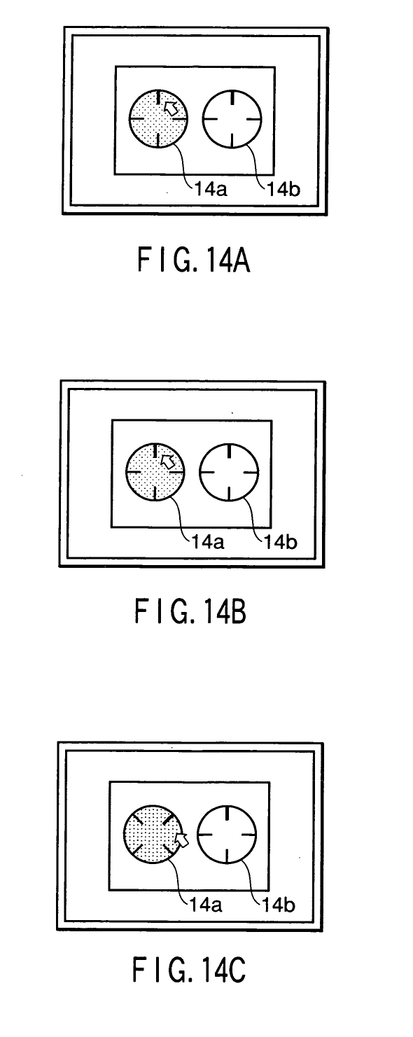

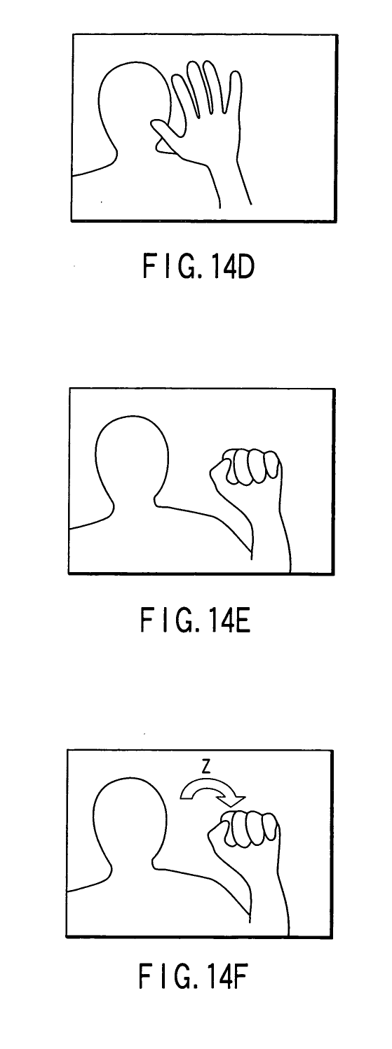

Referring to FIG. 13 and FIGS. 14A through 14F, a description is given of a process of controlling a dial by gestures as a fourth embodiment of the invention. In an information processing method according to the fourth embodiment, a dial is displayed on the display 115 when the user uses the first hand shape. Hereinafter, a description is given of an exemplary case where the information processing method according to the fourth embodiment of the invention is applied to the personal computer 100 shown in FIG. 1. Additionally, in the following description, it is assumed that an open hand is used as the first hand shape, and a fist is used as the second hand shape.

FIG. 13 is an exemplary flowchart for explaining the information processing method according to the fourth embodiment of the invention. FIGS. 14A, 14B and 14C are exemplary schematic diagrams showing examples of a dial displayed on the display 115 of the personal computer 100. FIGS. 14D, 14E and 14F are exemplary schematic diagrams showing examples of the image of the user photographed by the camera 126.

First, the image of the user is photographed by the camera 126 (S1300). On this occasion, an image as shown in FIG. 14D, for example, is photographed. The photographed image is supplied from the camera 126 to the hand-shape recognition unit 127. The hand-shape recognition unit 127 recognizes a hand shape included in the supplied image, and outputs the identifier and coordinates of the hand shape (S1301). In other words, in S1301, the hand-shape recognition unit 127 determines whether or not the supplied image includes the first hand shape.

When any of the hand shapes stored in (registered with) the hand-shape database 128 is included in the supplied image (FIG. 14D), the hand-shape recognition unit 127 supplies, to the gesture interpretation unit 129, predetermined hand-shape coordinate information including the identifier and the position information of the first hand shape. The gesture interpretation unit 129 interprets a user's gesture based on the supplied information, and changes the position and state of the user cursor (S1302). When the first hand shape (i.e., open hand) is recognized by the hand-shape recognition unit 127 (YES in S1303), i.e., when the supplied image includes the first hand shape, based on the interpretation result, the gesture interpretation unit 129 controls the graphics controller 114 so as to display a dial on the display 115 (S1306). When it is determined for the first time that the supplied image includes the first hand shape, the user cursor and two kinds of dials 14a and 14b as shown in FIG. 14A, for example, are displayed on the display 115, and the process returns to S1300. When the dial 14a is selected by the user cursor, the display color of the dial 14a can be changed, so as to inform the user of a fact that the dial 14a is currently selected.

The process of S1300 through S1306 is repeated until the user changes his/her right hand from the first hand shape (open hand) to the second hand shape (fist). In other words, the process of S1300 through S1306 is repeated as long as the user is moving the user cursor by using the first hand shape.

On the other hand, as a result of interpreting the output from the hand-shape recognition unit 127 by the gesture interpretation unit 129, when it is determined that the supplied image does not include the first hand shape (NO in S1303), the gesture interpretation unit 129 determines whether or not the supplied image includes the second hand shape (S1308). When it is determined that the supplied image does not include the second hand shape (NO in S1308), the process returns to S1300.

For example, a case is assumed where an image including the second hand shape (fist) as shown in FIG. 14E is supplied from the camera 126 (S1300). In this case, the gesture interpretation unit 129 determines that the supplied image (FIG. 14E) does not include the first hand shape (NO in S1303) but includes the second hand shape (fist) (YES in S1308). Based on the interpretation result, the gesture interpretation unit 129 controls, via the graphics controller 114, the user cursor and the dials 14a and 14b displayed on the display 115 (S1310), and transmits a command to the software 130 to be operated (S1312).

For example, in a state where the dial 14a is selected (FIG. 14A), when it is determined that the image includes the second hand shape (YES in S1308), the dial 14a enters a state allowing rotation (dragging) of the dial 14a in the clockwise direction and/or the counterclockwise direction. The dial 14a and/or the dial 14b can be configured to allow rotation for more than once. On this occasion, by changing the display state of the dial 14a, it is possible to inform the user of the state where the dial 14a can be rotated.

As for the display states of a selected dial (14a, 14b), various display states are conceivable: changing of the display color of the selected dial; blinking of the selected dial; and displaying the outline of the selected dial with a bold line. However, the display state of the selected dial is not limited to the display states as listed above. An arbitrary display state can be employed as long as the display state can inform the user of the dial which is currently selected (which can be rotated).

Next, a case is assumed where an image is photographed by the camera 126 after the user moves his/her right hand in a direction indicated by an arrow Z in FIG. 14F so as to draw an arc (or a circle) while maintaining his/her right hand in the second hand shape in a state where the dial 14a can be rotated (FIG. 14B) (S1300). In this case, the hand-shape recognition unit 127 supplies, to the gesture interpretation unit 129, the identifier (e.g., “2”) of the second hand shape and the position information (e.g., (x, y)=(15, 4)) after the movement (S1308). Based on the supplied information, the gesture interpretation unit 129 interprets and converts the user's gesture into a rotation angle of the dial 14a (S1310). As for the rotation angle of the dial 14a, an angle can be used which is formed between a line connecting a center point of the dial 14a to an initial position where the second hand shape is detected and a line connecting the center point to the position of the second hand shape after the movement. Alternatively, the rotation angle may be changed in accordance with the amount the user moves his/her right hand while maintaining his/her right hand in the second hand shape. Based on the interpretation result, the gesture interpretation unit 129 controls display of the dial 14a on the display 115 via the graphics controller 114 (S1310), and transmits a command to the software 130 (S1312).

It should be noted that display of the dials 14a and 14b may be ended when one of the dials 14a and 14b is rotated. Additionally, a button for ending display of the dials 14a and 14b may be displayed together with the dials 14a and 14b, and display of the dials 14a and 14b may be ended when the user changes his/her right hand from the first hand shape to the second hand shape in a state where the user selects the button by using the first hand shape. Further, display of the dials 14a and 14b may be ended when an image is photographed by the camera 126 which includes neither the first hand shape nor the second hand shape. The above description is given of the case where two kinds of dials 14a and 14b are displayed on the display 115. However, the number of dials displayed on the display 115 may be three or more. Alternatively, only one kind of dial may be displayed on the display 115. In this case, without performing control of changing the display state of a selected dial, the dial may enter a state allowing rotation when it is determined that a supplied image includes the second hand shape.

In addition, the dials 14a and 14b shown in FIGS. 14A through 14C may be displayed on the display 115 concurrently with one or both of the menu shown in FIGS. 7A through 7C and the slider bars 12a and 12b shown in FIGS. 12A through 12C.

Further, the gesture interpretation unit 129 may be configured to increase the rotation angle (or the number of rotations) of the dial (14a, 14b) when the user rotates his/her right hand (left hand) with a large radius or when the user quickly rotate his/her hand while maintaining the right hand in the second hand shape.

With the above-mentioned information processing method according to the fourth embodiment of the invention, it is possible for the user to select a dial and rotate the dial merely by remembering two kinds of hand shapes (the first hand shape and the second hand shape). Thus, a function associated with the dial can be controlled in accordance with the rotation angle of the dial. Accordingly, it is unnecessary for the user to remember many kinds of gestures, and thus user's burden is reduced.

Further, the dial (14a, 14b) may be configured to be rotatable more than once (multiple times). In this case, it is possible to allocate the dial a function having a wide range of selectable values. Thus, highly accurate control is performed in accordance with the number of rotations of the dial. For example, when a dial is associated with a function of adjusting a playback position (frame) of a moving image over one hour, the user can easily select a desired scene (frame) by adjusting the playback position of the moving image by rotating the dial.

In addition, since the user cursor is displayed on the display 115, the user can easily confirm which dial is currently selected. Further, in the case where a plurality of kinds of dials are displayed on the display 115, the display state of a selected dial is changed. Thus, the user can easily confirm which dial is currently selected.

Additionally, merely selecting a dial (14a, 14b) by using the first hand shape does not cause rotation of the selected dial. When the user changes his/her right hand (or left hand) from the first hand shape to the second hand shape, the selected dial can be rotated. Accordingly, it is possible to prevent operation (rotation) of an unintended dial while the user is moving the user cursor.

Further, the dials 14a and 14b can be displayed on the display 115 when it is determined that the photographed image includes the first hand shape, and display of the dials 14a and 14b may be ended when it is determined that the photographed image includes neither the first hand shape nor the second hand shape. Thus, the user can display the dials 14a and 14b on the display 115 according to need. Additionally, the dials 14a and 14b may be displayed on the display 115 by using the entire screen of the display 115. Further, generally, when the personal computer 100 is provided with a dial function, a hardware device for realizing the dial function is added to the personal computer 100. However, according to the fourth embodiment of the invention, it is possible to provide the personal computer with the dial function without adding a hardware device.

The above description is given of the cases where the information processing methods according to the second, third and fourth embodiments of the invention are applied to the personal computer 100. However, each of the information processing method according to the second, third and fourth embodiments of the invention can be applied to various kinds of information processing apparatuses, such as a television set, a desktop personal computer, a notebook personal computer, or a game machine.

Additionally, each of the information processing methods according to the second, third and fourth embodiments of the invention can be realized as a program which can be executed by a computer.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a display;
a hand-shape database which stores first data representing a first hand shape and second data representing a second hand shape;
a hand-shape recognition unit which receives an image supplied from a camera, determines whether or not the image includes one of the first hand shape and the second hand shape stored in the hand-shape database, outputs first predetermined information including position information representing a position of the first hand shape within the image when the image includes the first hand shape, and outputs second predetermined information when the image includes the second hand shape; and
a gesture interpretation unit which, when the first predetermined information is received from the hand-shape recognition unit, displays on the display a user interface including a plurality of display items each associated with an executable function, selects one of the display items in accordance with the position information included in the first predetermined information, and when the second predetermined information is received from the hand-shape recognition unit in a state where the one of the display items is selected, executes the executable function associated with the selected one of the display items.

2. The information processing apparatus according to claim 1, wherein the first predetermined information includes the position information and a first identifier representing the first hand shape, and
the second predetermined information includes a second identifier representing the second hand shape.

3. The information processing apparatus according to claim 1, wherein the user interface comprises one of: a first user interface including a plurality of buttons as the display items; a second user interface including a plurality of slider bars as the display items; and a third user interface including a plurality of dials as the display items.

4. An information processing method, comprising:
receiving an image supplied from a camera;
determining whether or not the image includes one of a first hand shape and a second hand shape stored in a hand-shape database;
outputting, when the image includes the first hand shape, first predetermined information including position information representing a position of the first hand shape within the image;
outputting, when the image includes the second hand shape, second predetermined information;
displaying, when the first predetermined information is output, on a display a user interface including a plurality of display items each associated with an executable function, and selecting one of the display items in accordance with the position information included in the first predetermined information; and
executing, when the second predetermined information is output in a state where the one of the display items is selected, the executable function associated with the selected one of the display items.

5. The information processing method according to claim 4, wherein the first predetermined information includes the position information and a first identifier representing the first hand shape, and
the second predetermined information includes a second identifier representing the second hand shape.

6. The information processing method according to claim 4, wherein the user interface comprises one of: a first user interface including a plurality of buttons as the display items; a second user interface including a plurality of slider bars as the display items; and a third user interface including a plurality of dials as the display items.

7. A computer program product configured to store program instructions for execution on a computer system enabling the computer system to perform:
receiving an image supplied from a camera;
determining whether or not the image includes one of a first hand shape and a second hand shape stored in a hand-shape database;
outputting, when the image includes the first hand shape, first predetermined information including position information representing a position of the first hand shape within the image;
outputting, when the image includes the second hand shape, second predetermined information;
displaying, when the first predetermined information is output, on a display a user interface including a plurality of display items each associated with an executable function, and selecting one of the display items in accordance with the position information included in the first predetermined information; and
executing, when the second predetermined information is output in a state where the one of the display items is selected, the executable function associated with the selected one of the display items.

8. The computer program product according to claim 7, wherein the first predetermined information includes the position information and a first identifier representing the first hand shape, and
the second predetermined information includes a second identifier representing the second hand shape.

9. The computer program product according to claim 7, wherein the user interface comprises one of: a first user interface including a plurality of buttons as the display items; a second user interface including a plurality of slider bars as the display items; and a third user interface including a plurality of dials as the display items.
